(19) United States
(12) Patent Application Publication
(10) Pub. No.: US 2008/0050202 A1
(43) Pub. Date: Feb. 28, 2008

(54) Fastening device

(76) Inventor: Yu-Chiao Liu, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/507,552

(22) Filed: Aug. 22, 2006

(51) Int. Cl. F16B 19/00

(52) U.S. Cl. 411/508

(57) ABSTRACT

A fastening device includes a main body and a first wedging part extending from the main body and fastened onto a first element. A pin passes through the main body. One end of the pin contacts the back surface of the first wedging part, and the second end of the pin has a second wedging part that is fastened onto a second element. Thereby, the first wedging part and the wedging fastening part fasten the second element on the first element firmly. The structure of the fastening device is simple, and the fastening effect is good.

### BACKGROUND OF THE INVENTION

1. Field of the Invention

The present invention relates to a fastening device.

2. Description of the Related Art

Interface cards are communication interfaces between computer motherboards and their peripherals. As portable electronic apparatuses have become thinner and thinner, the interface cards have also become smaller. For example, an interface card with a Mini PCE format commonly used in laptops has a horizontal-plugging design. The interface card is plugged into the connector and contacts with the bottom of the motherboard to reduce the interface card's height. The interface card is fixed to the connector via a holding force provided by the connector and a fastening device located on the motherboard. China patent CN 200410001481.4 discloses such a fastening device. A metal material is punched and bent many times to form the fastening device. The structure is complex, the manufacturing process is difficult, and the cost is high. Furthermore, after the fastening device has been used for a long period, the fastening part of the fastening element deforms thus rendering the fastening device less valuable.

### SUMMARY OF THE INVENTION

One particular aspect of the present invention is to provide a fastening device. Its structure is simple, and the fastening device fastens the fastening element well.

The fastening device includes a main body and a first wedging part extending from the main body and fastened on to a first element. A pin passes through the main body. One end of the pin contacts the back surface of the first wedging part, and a second end of the pin has a second wedging part that is fastened on to a second element.

The fastening device of the present invention has the first wedging part that is fastened on to the first element, and a pin passes through the main body. One end of the pin contacts the back surface of the first wedging part and the second end of the pin has a second wedging part that is fastened on to a second element. Therefore, the first wedging part and the wedging fastening part fasten the second element onto the first element firmly.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is an assembly perspective view of the fastening device of the present invention;

FIG. 2 is an exploded perspective view of the fastening device of FIG. 1;

FIG. 3 is a perspective view of the two main bodies of the fastening device of FIG. 1;

FIG. 4 is another perspective view of the two main bodies of FIG. 3;

FIG. 5 is a schematic diagram of the fastening device of FIG. 1 assembled with an interface card, an electrical connector, and a circuit board; and

FIG. 6 is a front view of FIG. 5.

### DETAILED DESCRIPTION OF THE PREFERRED EMBODIMENTS

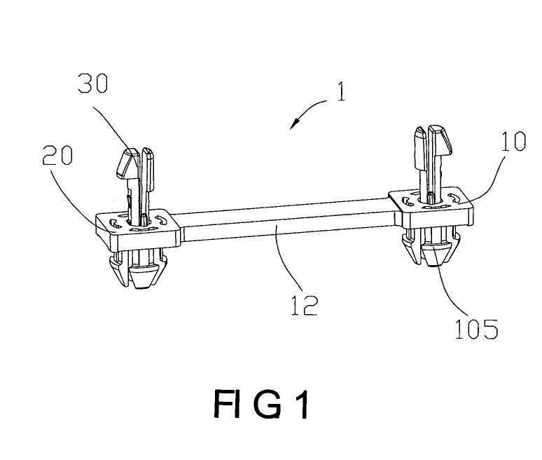

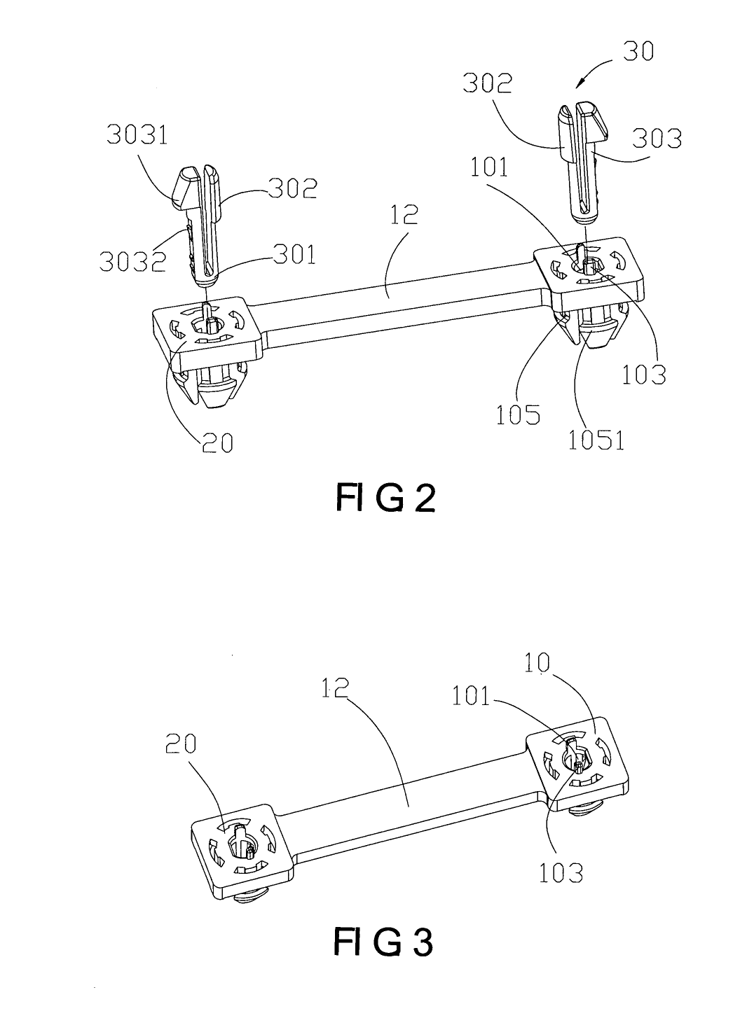

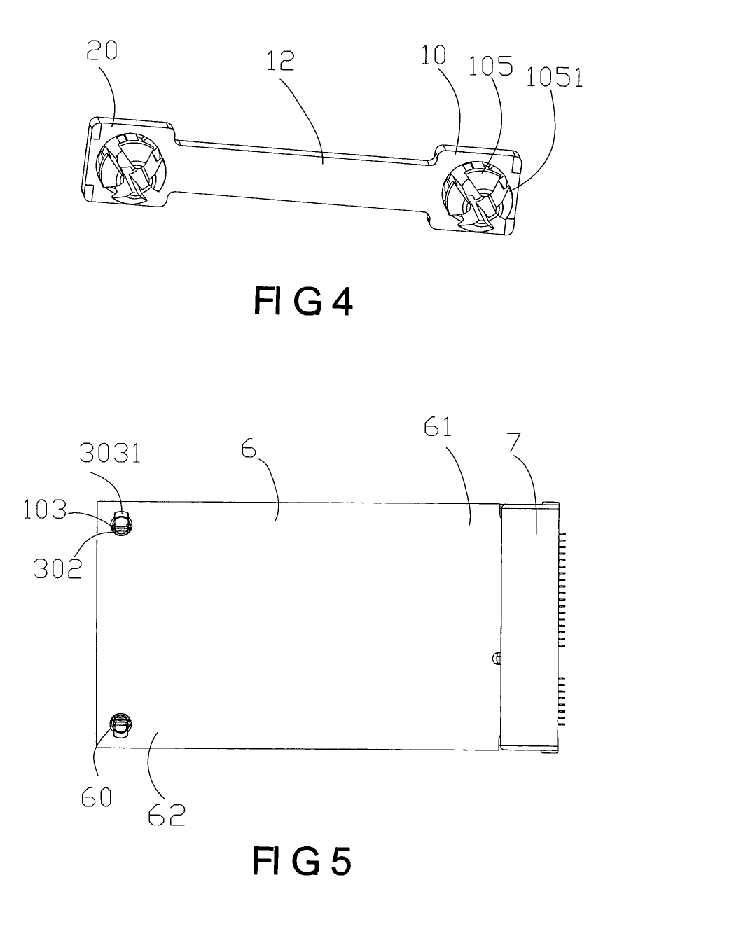

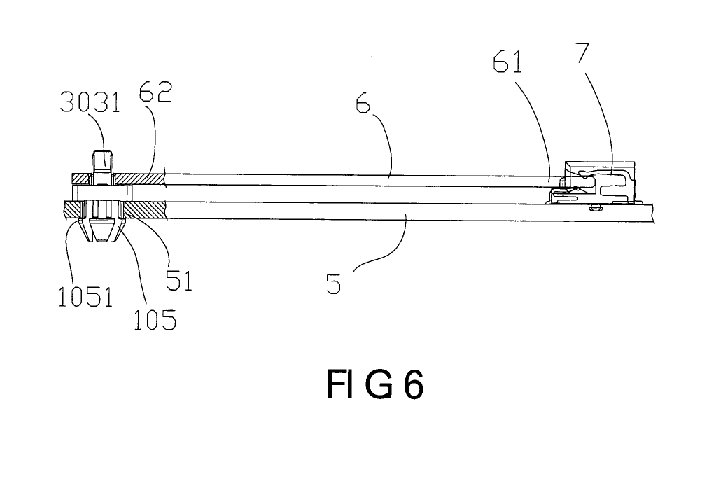

Reference is made to FIGS. 1˜6, the fastening device 1 of the present invention is fixed onto a first element (in this embodiment, the first element is a circuit board 5) for fastening a second element (in this embodiment, the second element is an interface card 6, alternatively, the second element can be other elements, such as a circuit board) that operates with an electronic connector 7 installed on the circuit board 5. A first end 61 of the interface card 6 is connected with the electronic connector 7. The fastening device 1 is fixed on a second end 62 located on the interface card 6 that is opposite the first end 61, and extends forward to the first end 61 of the interface card 6 and is wedged with the second end 62.

The fastening device 1 includes a first main body 10 and a second main body 20 that has the same structure, and two pins 30 that match the two main bodies 10, 20. Alternatively, the fastening device 1 only has a single main body, and a single pin.

There is a connecting part 12 between the first main body 10 and the second main body 20. The connecting part 12 connects the first main body 10 and the second main body 20 into a single structure to form the fastening structure with two wedging structures. On the first main body 10, there is a through hole 101. Two second positioning parts 103 extend upwards from the edge of the through hole 101 located on the upper surface of the first main body 10. A first wedging part 105 extends downward from the edge of the through hole located on the lower surface of the first main body 10. The first wedging part 105 includes four parts that are separated from each other (alternatively, there can be two, three, or more parts.) At an end of each of the parts of the first wedging part 105, there is a first hooking part 1051. When the fastening device 1 is installed on the hole 51 located on the circuit board 5, the hooking part 1051 is fastened onto the circuit board 5 to firmly connect the fastening device onto the circuit board.

The pin 30 includes a plugging part 301, a first positioning part 302, and a second wedging part 303 extending upward from two sides of the plugging part 301. At one end of the second wedging part 303, there is a second hooking part 3031 that can be wedged with the interface card 6. There is a shoulder part 3032 that is adjacent to the center position of the second wedging part 303. The shoulder part 3032 has an inverse hook. When the pin 30 is installed into the through hole 101 of the first main 10, the pin 30 is connected with the first main body 10 firmly via the shoulder part 3032.

In this embodiment, the pin 30 installed on the first main body 10 is described (the illustration for installing the pin 30 on the second main body 20 is omitted, because it is the same as that of installing the pin 30 on the first main body 10). When the pin 30 is plugged into the two main bodies 10 and 20, the first wedging part 105 has been installed on the circuit board 5. The plugging part 301 of the pin 30 aligns with the through hole 101 of the first main body 10 and is pressed to make the pin 30 reach and contact the back surface of the first wedging part 105. At this time, the second positioning part 103 supports the first positioning part 302. The pin 30 is connected with the first main body 10 firmly via the shoulder part 3032.

When the interface card 6 is installed, the first end 61 of the interface card 6 is plugged into the electrical connector 7. Next, the hole 60 of the interface card 6 aligns with the pin 30 and the second end 62 of the interface card 6 is pressed downward. Therefore, the second hooking part 3031 moves forward in a radial direction of the pin 30. When the hole 60 of the interface card 6 passes through the second hooking part 3031, the first positioning part 302 and the second positioning part 103 are positioned on the inner wall of the hole 60 of the interface card 6. Then, the second hooking part 3031 rebounds inward. At this time, the second hooking part 3031 wedges and presses on the upper surface of the interface card 6. When the interface card 6 is taken out, the second hooking part 3031 is moved in the radial direction of the pin 30, and the interface card 6 springs out. Because the interface card 6 is fixed on the fastening device 1 firmly via the positioning parts and the second hooking part 3031, the connection between the interface card 6 and the electrical connector 7 is assured. Furthermore, because the fastening device 1 can be located on the bottom of the interface card 6, the fastening device 1 does not need to be located on the out side of the interface card 6. Thereby, the required space is reduced.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A fastening device, comprising:
a main body; and
a first wedging part extending from the main body and fastened onto a first element;
wherein a pin passes through the main body, one end of the pin contacts the back surface of the first wedging part and the second end of the pin has a second wedging part that is fastened onto a second element.

2. The fastening device as claimed in claim 1, wherein there is a first hooking part located at one end of the first wedging part.

3. The fastening device as claimed in claim 1, wherein the first wedging part comprises at least two parts that separate from each other.

4. The fastening device as claimed in claim 1, wherein the second wedging part comprises a second hooking part that is wedged with the second element.

5. The fastening device as claimed in claim 1, wherein the second wedging part comprises a shoulder part that fixes the pin in the main body firmly.

6. The fastening device as claimed in claim 5, wherein the shoulder comprises an inverse hook.

7. The fastening device as claimed in claim 1, further comprising a first positioning part that positions the second element.

8. The fastening device as claimed in claim 7, wherein the first positioning part extends from the one end of the pin.

9. The fastening device as claimed in claim 1, further comprising a second positioning part that supports the first positioning part and positions the second element.

10. The fastening device as claimed in claim 1, wherein a second main body is located on the second side of the fastening device that is opposite to the main body and has the same structure as that of the main body.

11. The fastening device as claimed in claim 1, wherein fastening device operates with an electrical connector installed on an circuit board, a first end of a wedged object is connected with the electrical connector and a second end of the wedged object is wedged into the second wedging part of the fastening device.
